(19) United States
(12) Patent Application Publication
(10) Pub. No.: US 2025/0198012 A1
(43) Pub. Date: Jun. 19, 2025

(54) ELECTROLYSER AND METHOD FOR OPERATING AN ELECTROLYSER

(71) Applicant: Siemens Energy Global GmbH & Co. KG, München (DE)

(72) Inventors: Alexander Tremel, Möhrendorf (DE); Markus Ungerer, Baiersdorf (DE); Du-Fhan Choi, Düsseldorf (DE); Bernd Merkl, Igensdorf (DE)

(21) Appl. No.: 18/847,294

(22) PCT Filed: Jan. 9, 2023
(86) PCT No.: PCT/EP2023/050264

§ 371 Date: Sep. 16, 2024

(30) Foreign Application Priority Data
Mar. 31, 2022 (DE) 10 2022 203 193.8

(51) Int. Cl. C25B 1/04; C25B 9/67; C25B 9/70; C25B 15/08

(52) U.S. Cl. CPC C25B 1/04; C25B 9/67; C25B 9/70; C25B 15/083; C25B 15/087

(57) ABSTRACT

The invention pertains to an electrolyser for producing hydrogen (H₂) and oxygen (O₂) as product gases. It includes an electrolysis module and a gas separator for phase separation of the product gas from water. The electrolysis module is connected to the gas separator via a product flow line, and a return line with a circulation pump connects the gas separator back to the electrolysis module for separated water. A bypass line with a valve allows water to be supplied from the gas separator to the electrolysis module during standstill. The invention also covers a method for operating the electrolyser, where in standstill mode, the electrolysis current is stopped, and a safety deactivation is initiated. Water is automatically driven into the electrolysis module due to a hydrostatic differential pressure (Δp) from a predefined height difference (Δh), flooding the electrolysis module.

### BACKGROUND

The invention relates to an electrolyzer and to a method of operating an electrolyzer.

An electrolyzer is an industrial plant that brings about electrochemical conversion of matter with the aid of electrical current, called electrolysis. In accordance with the variety of different electrolyses, there is also a variety of electrolyzers, for example an electrolyzer for water electrolysis, i.e. the breakdown of water as reactant into oxygen and hydrogen product gases.

There have been increased considerations for some time as to production of materials of value with surplus energy from renewable energy sources in periods with a lot of sun and a lot of wind, i.e. with above-average generation of solar power or wind power. A material of value may especially be hydrogen, which is produced with water electrolyzers. Hydrogen can be used to produce, for example, what is called renewable energy gas.

An electrolyzer generally has a multitude of electrolysis cells adjacent to one another in a stacked arrangement. By means of water electrolysis, water is broken down in the electrolysis cells to hydrogen and oxygen. In a PEM electrolyzer, water distilled on the anode side is typically supplied as reactant and split into hydrogen and oxygen at a proton-permeable membrane (proton exchange membrane; PEM). Meanwhile, the water is oxidized to oxygen at the anode. The protons pass through the proton-permeable membrane. Hydrogen is produced on the cathode side. Meanwhile, the water is generally conveyed from a bottom side into the anode space and/or cathode space.

In an electrolyzer, the individual electrolysis cells are typically stacked to form a module comprising a multitude of individual cells in an axial direction and assembled to form the module or electrolysis module. An electrolyzer typically has a plurality of modules that collectively form what is called an electrolysis stack or simply stack. For example, 50 electrolysis cells may be stacked axially to form a module and in turn, for example, 5 modules may be stacked in axial direction to form a stack, such that an electrolysis stack of this kind may therefore comprise 250 cells, for example, in an axial overall assembly.

As soon as the electrolysis modules in a PEM electrolyzer, or the electrolysis cells or the electrolysis stack, are filled with water for the first time, for example after manufacture, it has to be ensured that water (reactant water), or a water-gas mixture in operation of the electrolyzer, always remains in the modules. Running-dry or drying-out has to be prevented in every phase of operation since this would lead to irreversible damage to the electrolyzer. The membrane in particular must always be kept in a moist medium, but there are other functional parts and components, for instance the catalyst or the electrodes, that must not dry out either.

In a phase of operation with a planned and pending maintenance or service of the electrolyzer from a normal state of operation, for instance for servicing purposes, stoppage management of the electrolyzer is generally efficiently plannable in advance, and appropriate precautions and shutdown procedures can be initiated in a routine and safe manner, such that, in particular, even after shutdown, water remains in the modules and can additionally also be circulated.

By contrast, unforeseen and in particular safety-related rapid shutdowns at very short notice or even instantaneous emergency shutdowns in the event of faults can present quite considerable problems. These can be controlled only with quite some difficulty and a high level of technical complexity, particularly with regard to preventing the modules from running dry in stoppage operation. This is all the more true in that there are different types of electrolyzers each with different construction and different operating parameters, with which specific operation risks and causes for a safety shutdown or an emergency shutdown have to be taken into account. For instance, there are known atmospheric electrolyzers that work at an atmospheric or only low operating pressure, but also pressure electrolyzers that work at a high operating pressure of 35 bar or much higher.

### SUMMARY

It is therefore an object of the invention to specify an electrolyzer where stoppage operation is implementable in a technically simple and safe manner, such that running-dry is prevented with a high level of reliability. A further object is that of specifying a method of operating an electrolyzer in stoppage operation with low propensity to failure and high flexibility.

The object directed to an electrolyzer is achieved in accordance with the invention by an electrolyzer for production of hydrogen and oxygen as product gases, comprising an electrolysis module and a gas separator designed for phase separation of the product gas from water, in which the electrolysis module is connected to the gas separator via a product flow conduit for the product gas, and in which a return conduit for the water removed is provided, which fluidically connects the gas separator to the electrolysis module, wherein a circulation pump is connected into the return conduit, and in which a bypass conduit having a fitting is provided, which connects the gas separator to the electrolysis module, wherein at least part of the return conduit is fluidically bypassed by the bypass conduit, and wherein the bypass conduit having the fitting is designed such that water is autonomously suppliable from the gas separator to the electrolysis module via the bypass conduit in stoppage operation, wherein rapid flooding of the electrolysis module with water is ensured and the electrolysis module is prevented from running dry.

The invention proceeds from a recognition of the problem originating from a risk assessment and appraisal of different causes in that, for instance in the case of electrolysis modules at least partly filled with gas and with hydrogen on the cathode side and oxygen on the anode side, very rapid diffusion of the gases through the thin proton-permeable membrane takes place. Particularly hydrogen, which is a small molecule, then diffuses back onto the oxygen side. The effect is more pronounced when the operating pressure of the electrolyzer is higher, since a partial pressure differential is the driving force for the diffusion. The diffusion can lead to a hazardous gas concentration within minutes, i.e. to an increase in the hydrogen concentration on the oxygen side to above the lower explosion limit of 4 vol %. Since a source of ignition cannot be ruled out, for example a dried-out catalyst, an explosion is possible in the worst case.

The electrolysis modules must always be prevented from running dry in this situation.

In normal operation, a mixed phase is formed in the modules, i.e. a phase mixture of water and product gas, i.e. a water/hydrogen mixture on the hydrogen side and a water/oxygen mixture on the oxygen side. As soon as the power supplied to the electrolysis is stopped and no further measures are taken, the mixture would soon separate and a gas phase would form at least in the upper region of the electrolysis modules. Rapid supply of water and displacement of the gas is therefore also absolutely necessary in all conceivable fault scenarios in order to prevent drying-out. Safeguarding measures therefore have to be implemented immediately.

An additional exacerbating factor here is that it is a development goal in PEM electrolysis to use ever thinner membranes, which reduces electrical resistance across the membrane and increases the efficiency of the electrolyzer. However, thinner membranes lead disadvantageously to even higher diffusion and hence to an increase in any possible explosion risk.

It is therefore increasingly important in an electrolyzer to ensure particularly rapid flooding of the electrolysis modules with water in stoppage operation. The existing solutions are inadequate here or very complex and not very flexible with regard to the working pressure of the electrolyzer.

In this regard, the invention proposes, for the electrolyzer, a flooding concept for flooding the electrolysis modules with water, which is completely autonomous and is found to be very reliable and robust as an inherent part of the system. It is in particular independent of additional and complex external supplies and redundant systems or backup solutions for conveying or flooding by means of pump aggregates. The present plant concept for the electrolyzer is also advantageously usable independently of the working pressure of the electrolyzer, i.e. is flexibly applicable both to atmospheric electrolyzers and to pressure electrolyzers. In particular, it is possible to avoid critical states of operation, for instance due to an explosion risk, and at the same time to prevent running-dry, since rapid emptying of the gas separator is automatically brought about and driven by the bypass conduit specially provided for this purpose and by balancing of levels owing to the height differential and hence the pressure differential correspondingly maintained as a result of the water column. In particular, there is no need for external pump aggregates, or those that are maintained specially for this purpose, and for complex electrical emergency supply systems in order to bring about reliable and very rapid flooding of the electrolysis modules. The electrolysis cells and in particular the membrane are thus safely protected from drying out, since these components are immediately flooded and kept moist by the water driven back through the bypass conduit.

What is specially provided here for the flooding, particularly in the event of an emergency shutdown, is the bypass conduit having the fitting. The bypass conduit is fluidically guided substantially parallel to the return conduit and connects the gas separator and its water reservoir to the electrolysis module. In normal operation, the fitting is closed. Water removed is then returnable into the electrolysis module via the return conduit by means of the circulation pump. Depending on the configuration, part of the return conduit having the circulation pump or else the entirety thereof is fluidically bypassed by the bypass conduit.

This plant concept for an electrolyzer therefore enables a reliable, particularly rapid and automatic flooding of an electrolysis module with water by virtue of the bypass conduit and the water reservoir in the gas separator on opening of the fitting, advantageously effectible solely on the basis of the height differential. The present safety concept is superior to known solutions for electrolyzers, since it does not require redundancy and supplies are implementable irrespective of the working pressure of the electrolyzer.

In one embodiment, the gas separator in this regard is designed and disposed at a predetermined height differential above the electrolysis module such that, in the event of a stoppage, the electrolysis module is automatically floodable with water via the bypass conduit, driven solely by a hydrostatic differential pressure.

By designing and disposing the gas separator at a predetermined height above the electrolysis module, a sufficient minimum fill height or water level in the gas separator is constantly maintained in operation and a hydrostatic delivery pressure is already inherently provided in the system. What is thereby implemented is a safe shutdown operation or stoppage operation, particularly in the event of a safety-related emergency shutdown, which is maintained via the bypass conduit having the fitting. The flooding concept is of course also advantageously utilizable for a regular and planned shutdown of the electrolyzer, for instance for servicing purposes. In conjunction with the bypass conduit, the elevated position of the gas separator ensures a sufficient hydrostatic delivery pressure and a sufficient volume flow rate of water for flooding within a short time.

For instance, pressure electrolyzers are operated at a pressure of 35 bar, for example. At this high working pressure, the volumetric gas content in the electrolysis module is low, meaning that only a small amount of gas can separate in volumetric terms after the shutdown. The pipelines from the electrolysis module generally ascend to the gas separators, such that, after shutdown, water can partly separate even in the pipelines and flow back into the electrolysis module. However, this does not take place sufficiently rapidly in the event of an emergency shutdown, for instance in the event of a risk of explosion, and, moreover, requires active components in order to convey the water actively and rapidly into the electrolysis modules. It is also necessary to accordingly maintain an appropriate fill level in the gas separator for this situation. By virtue of operation under pressure, the diffusion of hydrogen from the cathode side through the membrane to the anode side of the electrolysis cell is increased, which is a safety-relevant problem that is increased as membranes are increasingly being designed more thinly.

By comparison with a pressure electrolyzer, in the case of an electrolyzer in atmospheric operation, there is a large volumetric amount of gas in the electrolysis module under operating conditions. The electrolysis modules are connected directly to gas separators above both via the inlet and the outlet. It is generally unnecessary to install a pump because of the natural circulation process. If there is still a sufficient amount of sufficiently dispersed gas in the electrolysis modules, this natural circulation does not stop either because of the difference in density caused thereby. After natural circulation has stopped, the water level in the electrolysis modules is well below that of the gas separators, and there are no significantly pressure drop-affected internals in between, such that water can run freely from the gas separators into the modules and can ensure the water level in the modules.

A conventional means of safeguarding fault scenarios in the case of forced circulation by means of pumps is the utilization of redundant pumps. In the event of a fault in one pump, the remaining pump capacity can be utilized in order to rapidly fill the modules with water. An uninterrupted power supply is needed in order to be able to counteract a power outage as well. Moreover, pumps should be actuated completely separately in order to be able to bypass control technology faults as well. All of this makes such solutions very complex and costly.

The concept of the invention, by contrast, can very effectively safeguard both pressure electrolyzers and atmospheric electrolyzers against running dry, and particularly rapid, automatic and autonomous flooding via the bypass conduit is possible without requirements for redundancy. The concept is found to be particularly advantageous in the case of atmospheric electrolyzers, but, as explained, is not limited thereto.

The plant concept of the invention for an electrolyzer therefore enables a particularly reliable and rapid flooding of an electrolysis module with water by virtue of the bypass conduit and the water reservoir in the gas separator, with sufficient hydrostatic delivery pressure and an appropriately large water reservoir being available as a result of an appropriately elevated position of the gas separators.

The height differential is preferably adjusted such that the driving pressure differential provided for the flooding is at least 0.05 bar to 0.5 bar, in particular 0.1 bar to 0.3 bar.

In terms of design, it has been found that, with this differential pressure in the case of typical electrolyzers, a sufficient driving pressure force for level balancing is generally provided in order to initiate flooding as fast as possible when required through opening of the fitting in the bypass conduit. The sufficient differential pressure level and hence the higher positioning of the gas separator compared to the electrolysis module is advantageously adaptable to the particular situation. By providing the bypass conduit having just one fitting, disadvantageous effects due to conduit cross sections, component parts, and components that affect flow resistance and in the entire electrolysis module to be flooded on the flow path to the electrolysis module, are not a matter of concern with the bypass conduit. In conduits with many flow elements such as pumps and heat exchangers, these pressure drop coefficients can lead to altered and elevated differential pressures, which would be required for rapid flooding. The bypass conduit advantageously bypasses the return conduit having the circulation pump, thus advantageously circumventing the disadvantages of elevated pressure drop coefficients.

In one embodiment of the electrolyzer, the gas separator is configured as a horizontal vessel, such that a large surface area is provided as phase interface between liquid and gaseous phases.

This configuration of the electrolyzer permits a comparatively low overall build height of the gas separator, which is very advantageous in view of the positioning with sufficient height differential to be provided above the electrolysis module. The gas separator configured as a vessel accordingly has a vessel base having a length dimension and a width dimension, each of which is much greater than the vessel height. This advantageously saves build space in spite of the height differential required for building up hydrostatic pressure. Moreover, the horizontal design creates a correspondingly large phase interface in the gas separator between the water at the vessel base and product gas—oxygen or hydrogen—in the gas phase above the phase boundary, which in normal operation promotes more effective phase separation between water and product gas in the phase mixture. Effective phase separation is advantageous for stoppage operation as well.

In one embodiment, the bypass conduit opens directly into a lower region of the electrolysis module or into the return conduit with bypassing of the circulation pump on the discharge side thereof.

This mode of connection of the bypass conduit provides a maximum hydrostatic pressure differential and hence a corresponding filling pressure as a result of the difference in height between the gas separator and the electrolysis module in the electrolyzer. A higher differential pressure ensures faster backflow of the water and complete flooding of the electrolysis module via the bypass conduit in the event of a safety shutdown. The theoretically attainable maximum differential pressure (filling pressure) results simply from the hydrostatic pressure of the water column which is generated in the event of a height differential between the normal fill level in the gas separator and the level of the connection of the bypass conduit into the electrolysis module. In practice, the electrolysis module itself, however, already has a fill level, and so the differential pressure actually available for flooding arises from the height differential or the difference in level between the fill levels. The driving force for the flooding is the higher water level in the gas separator compared to the water level in the electrolysis module, such that automatic level balancing can be brought about.

In one embodiment, the fitting in the bypass conduit is configured as a valve, in particular as a solenoid valve which opens automatically in the de-energized state.

Here, a quite robust and simple fitting is sufficient with a short opening time and a large opening, such that the flow path in the bypass conduit for the flooding is released by the fitting without an appreciable pressure drop. Advantageously, use is made here of a solenoid valve which is closed in normal operation on activation by a current. In the event of a stoppage operation of the electrolyzer with or without associated power outage, the solenoid valve opens automatically in the de-energized state.

In one embodiment, the fitting is configured as a check valve which, in the event of a stoppage, opens automatically owing to the hydrostatic differential pressure. This is a particularly simple and robust mechanical solution which does not require a power supply and requires only little maintenance.

In one embodiment, at least two fittings in the bypass conduit are provided, which are fluidically parallel-connected into the bypass conduit. This creates redundancy in a very simple way in the event of one fitting failing in stoppage operation and not opening for stoppage operation or shutdown operation. Operational reliability for initiating flooding of the electrolysis module is thereby increased. Parallel-connected fittings considerably increase the reliability of necessary opening. It is possible here for two or more fittings to be parallel-connected into the bypass conduit. When choosing the type of fitting, combinations of solenoid valve and check valve, or other designs, are also advantageously possible.

In one embodiment, the return conduit opens into a lower region of the electrolysis module. This is particularly advantageous if the bypass conduit itself does not open directly into a lower region of the electrolysis module, but instead opens into the return conduit or, with advantageous bypassing of the circulation pump and any further flow elements, into a conduit section on the discharge side. Only one connection is required. Therefore, the one connection on the electrolysis module is usable not only for normal operation with regular recirculation of water into the electrolysis process, but also in stoppage operation for flooding via the bypass conduit with bypassing of the circulation pump and any further flow elements in the return conduit.

With this mode of connection of the bypass conduit in combination with the return conduit via just one connection on the electrolyzer, there is provided a maximum hydrostatic pressure differential as a result of the difference in height between the gas separator and the electrolysis module in the electrolyzer. A higher differential pressure ensures faster backflow of the water and complete flooding of the electrolysis module in the event of a safety shutdown. The differential pressure results simply from the hydrostatic pressure of the water column which is generated in the event of a height differential between the normal fill level in the gas separator and the lowest possible connection level of the common connection of the bypass conduit into the electrolysis module, in some cases ultimately via the return flow conduit. The driving force for the flooding is also in this case the higher water level in the gas separator compared to the electrolysis module, such that automatic level balancing can be brought about.

The partial or possibly complete bypassing of the return flow conduit by the bypass conduit means that, with regard to the bypassed flow components in the return flow conduit, there are no restrictions with regard to flow at stoppage. Here, there is no special design of the flow path in the return flow conduit with respect to pressure drop coefficient, and there is largely freedom in the selection and combination of available components, for instance circulation pump, heat exchanger, measuring devices or other components, which increase resistance coefficient.

Nevertheless, it may be advantageously preferred in certain applications to configure the circulation pump in the return conduit such that it has a low pressure drop coefficient at stoppage. This would be generally advantageous, since this would provide, if required, another flow path for fast backflow or flooding via the return flow conduit, thus achieving simple redundancy. There is then no need for possibly further redundancy by multiple parallel-connected fittings in the bypass conduit.

The pressure drop coefficient or else resistance coefficient (typical formula symbol ζ-zeta), in fluid mechanics, is a dimensionless measure of pressure drop in a flow component, such as a pipeline or fitting. This means that the pressure drop coefficient makes a statement as to what pressure difference has to exist between inflow and outflow in order to maintain a particular flow through the component. The pressure drop coefficient is always applicable to a particular geometric shape and is generally dependent on the Reynolds number and in some cases on the surface roughness of the flow-conducting component.

In normal operation of the electrolyzer, it is very advantageous to actively return the water separated in the gas separator into the electrolysis process, and therefore a circulation pump is provided in the return conduit, which continuously pumps the water back. However, the circulation pump is a resistive flow element which, in shutdown operation, for example, would counteract rapid backflow of the water in the flooding operation. It may therefore be advantageous to provide a very low pressure drop coefficient at stoppage for the circulation pump. Especially in combination with the bypass conduit, this increases the reliability of stoppage operation and, as desired, rapid flooding via multiple conduits and creates simple redundancy.

It has been found that, in this case, a pressure drop coefficient ζ of the circulation pump is preferably less than ζ=5, particularly less than ζ=3. This also provides, as required, throughflow or backflow of a sufficient volume flow rate of water through the circulation pump even at stoppage. However, the driving force remains the differential pressure as a result of the difference in height between gas separator and electrolysis module. But now a correspondingly adjusted and designed circulation pump, which passively assists the flooding via the low pressure drop coefficient, has advantageously been integrated into the electrolysis plant in combination with the bypass conduit. However, the leading component or flow path for the flooding is preferably the bypass conduit.

In one embodiment, multiple electrolysis modules are provided, which are connected to the gas separator via a common product flow conduit.

The output of the electrolyzer or of the electrolysis plant is thus scalable in a simple and flexible manner by providing further electrolysis modules. The electrolysis modules may be operated in a parallel connection or else in series connection as what are called module rows or combinations thereof. With regard to terminology, a parallel connection may relate to the purely electrical interconnection with regard to the electrolysis current or electrolysis voltage and/or with regard to the streams of matter, for instance the guiding and directing of the process water as reactant stream through the electrolysis modules.

In one embodiment, in the case of multiple electrolysis modules, the electrolysis modules are connected to the return conduit via a respective terminal conduit, with a control valve disposed in at least one of the terminal conduits. Preference is given here to a configuration in which a respective control valve is provided in each of the terminal conduits, since this enables particularly high operational flexibility, for instance the flooding of only one or only individual electrolysis modules where required for servicing purposes or in a safety shutdown.

If, for instance, multiple parallel-connected electrolysis modules or module rows are supplied by a pump or pump station, respective control valves are therefore preferably provided in order to enable individually controllable flow to each electrolysis module or each module row.

In the case of use of multiple parallel pumps, for instance for provision of redundancy, it is preferable that the flow through a pump is also of sufficient size, i.e. the pressure drop coefficient. This advantageously permits, for example, what is called the gating-off and exchange of pumps and further operation with at least one pump through which free flow is possible. A gate valve—also called gas or water valve—is a fitting which is usually utilized for complete opening or closure of the entire flow cross section of a pipe or conduit. By contrast with valves, gate valves are not used primarily for regulation of flow rate and not at very high pressure. Gate valves often serve as a primary barrier, i.e. in order to enable maintenance work on downstream fittings that assume the gating or regulation function in regular operation.

Although, in the design concept of the invention, the bypass conduit is preferably provided as the leading component or prominent flow path for the flooding of the electrolysis module, it may be generally advantageous to provide a minimum permissible pressure drop coefficient at the component level for an electrolysis plant. Thus, if additional flow components or elements, for example heat exchangers, valves and filters, are used in a flow path, particularly in the return flow conduit, it may be preferable to take into account the pressure drop coefficient. It is then possible, at least within certain limits to partially compensate for an otherwise necessary adjustment of the difference in height, i.e. a correspondingly even higher differential pressure as the driving force for the flooding. The return flow conduit in particular is thereby also strengthened for flooding if necessary, specifically as an alternative to or in addition to the bypass conduit as a redundant flow path.

The control valve is then preferably mechanically designed for a minimum flow below which the flow cannot be reduced during control. The minimum opening may be implemented by a corresponding mechanical barrier. A corresponding configuration of the control valve is preferably also provided in the case of multiple control valves that are each connected into a terminal conduit.

This minimum opening of the valve position for a minimum flow through the control valve, together with the pressure drop coefficient of the circulation pump and/or the pressure drop coefficient of a pump station comprising multiple pumps in the electrolyzer, is advantageously set and configured so as to ensure sufficiently rapid automatic backflow of water from the gas separator to the electrolysis module to be flooded solely on the basis of the differential pressure or the difference in height. Although, in the design concept of the invention, the bypass conduit is preferably provided as the leading component or prominent flow path for the flooding of the electrolysis module, it may be advantageous to provide minimum permissible pressure drop coefficients at stoppage for other flow paths too, for example a corresponding minimum flow through the available control valves.

In one embodiment, a control valve is connected into the return conduit on the discharge side of the circulation pump. As a result, the backflow of water from the gas separator is controllable in normal operation and the volume flow rate is adjustable to the operation of the electrolyzer. The bypass conduit is fluidically guided parallel to the return flow conduit and, in this embodiment, bypasses both the circulation pump and the control valve. The bypass conduit preferably opens into the return conduit downstream of the control valve or, alternatively, is preferably connected to the electrolysis module by way of a separate connection.

In one embodiment, a heat exchanger is connected into the return conduit between the circulation pump and the control valve. Process heat can therefore be recovered from the returned water from the gas separator and dissipated via a heat exchanger. The water is cooled to a temperature level and, besides the electrolysis process, can be simultaneously used for cooling of the electrolysis module.

The object directed to a method of operating an electrolyzer is achieved in accordance with the invention by a method, in which an electrolysis current is supplied to an electrolysis module in normal operation, such that water is converted to hydrogen and oxygen as product gases in the electrolysis module, wherein product gas is supplied to a gas separator in a phase mixture of water and product gas, wherein water is separated from product gas in the gas separator, and wherein, in stoppage operation, the electrolysis current is stopped and a safety shutdown is initiated. Here, water is driven out of the gas separator automatically into the electrolysis module on account of a hydrostatic differential pressure associated with a predetermined height differential, wherein the electrolysis module is flooded with water, wherein rapid flooding of the electrolysis module is ensured and the electrolysis module is prevented from running dry.

In one embodiment, the safety shutdown involves automatic opening of a fitting and driving of the water into the electrolysis module via a bypass conduit.

The electrolysis module is preferably flooded automatically here with water until the fill level of water in the gas separator and the fill level in the electrolysis module are balanced.

When operation is suddenly stopped, for example as a result of a safety shutdown or an emergency shutdown of the electrolysis, product gas and water will separate in the electrolysis module. A certain water level or fill level will be established in the electrolysis module. Because the gas separator is higher and appropriately designed, water will be immediately and rapidly driven into the electrolysis module because of the differential pressure that exists, and there can even be sufficiently rapid flow through any flow elements present in the conduits. Balancing of levels is thus brought about very rapidly and automatically, and rapid flooding of the electrolysis module is achieved. The electrolysis cells in the electrolysis module and in particular the sensitive membranes are fully soaked with water and cannot dry out. Running-dry is reliably prevented.

Further advantages of the method will be correspondingly apparent from the above-described advantages of the electrolyzer.

### BRIEF DESCRIPTION OF THE DRAWINGS

The invention is elucidated in detail hereinafter by the drawings that follow. It should be noted here that the working examples shown in the drawings serve primarily to illustrate the invention. However, they are not intended to restrict the invention.

The figures show, in schematic and highly simplified form:

FIG. 1 an electrolyzer with an electrolysis module;

FIG. 2 a diagram showing the progression of the fill level over time in the event of a safety shutdown.

Identical reference numerals in the figures have the same meaning.

### DETAILED DESCRIPTION

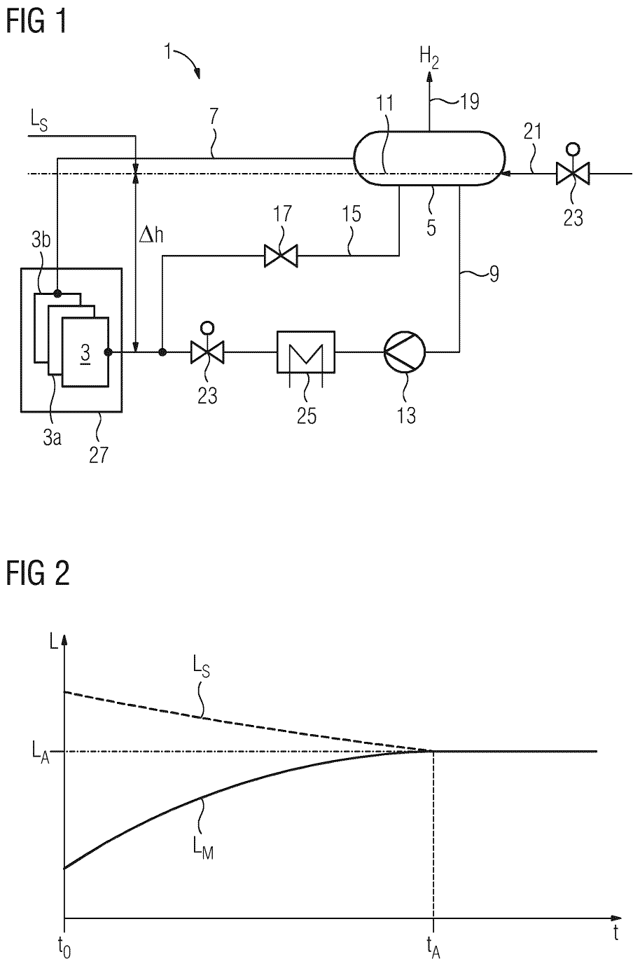

FIG. 1 shows an electrolyzer 1 for the electrolysis of water. The electrolyzer 1 has—in simplified form in the diagram—a circuit on the hydrogen side. A corresponding circuit is also possible in analogous consideration on the oxygen side. What is shown is a simple working example of an electrolyzer 1 in order to execute the invention and to elucidate the principle. The electrolyzer 1 has an electrolysis module 3 and a gas separator 5. The gas separator 5 is connected to the electrolysis module 3 via a product flow conduit 7. The electrolysis module 3 typically comprises an electrolysis cell stack, not shown in detail in FIG. 1, with a multitude of electrolysis cells stacked in an axial direction. An anodic half-cell and the cathodic half-cell of an electrolysis cell are separated by a proton-permeable membrane. As shown, it is also possible that multiple electrolysis modules 3, 3a, 3b are connected together to form a module arrangement 27. The electrolyzer 1 is configured for production of hydrogen H2 and oxygen O2 as product gases in a PEM electrolysis process, for example under atmospheric pressure conditions. The electrolysis module 3 is connected to the gas separator 5 via the product flow conduit 7 for the product gas. The gas separator 5 is designed for phase separation of the product gas from water, in the present case for separation of gaseous hydrogen H2 from the phase mixture with water in the gas separator 5. A return conduit 9 for the water removed fluidically connects the gas separator 5 to the electrolysis module 3. The return conduit 9 opens into the electrolysis module 3 at a geodetically lowest possible connection site, such that a correspondingly maximum hydrostatic pressure is achieved through the water column in the gas separator 5 in relation to the fill level LS in the gas separator and bears thereon. A circulation pump 13 is connected into the return conduit 9, which, in normal operation of the electrolyzer, actively delivers water separated from the phase mixture from the gas separator 5 into the electrolysis module 3 or circulates it in the circuit on the hydrogen side. The circulation pump 13 is supplied with electrical power. A bypass conduit 15 having a fitting 17 connects the gas separator 5 to the electrolysis module 3. The bypass conduit 15 opens into the return conduit 9 downstream of the circulation pump 13 or is connected thereto. It is also possible that the bypass conduit 15 is directly connected to the electrolysis module 3 without opening into the return conduit 9. In both connection variants, at least part of the return conduit 9 having the circulation pump 13 is fluidically bypassed by the bypass conduit 15 in a separate and parallel flow path for the water. A heat exchanger 25 and a control valve 23 are connected into the return conduit 9, such that, in normal operation of the electrolyzer 1, it is possible to carry out a controlled return of water and cooling of the water via the heat exchanger 25. Thus, in the event of a planned or unplanned stoppage of the electrolyzer 1, it is possible to rapidly supply water from the gas separator 5 to the electrolysis module 3 specifically via the bypass conduit 15 intended for this purpose, and it is possible to flood the electrolysis module 3 very effectively within the shortest possible time, such that the membrane in particular is reliably protected from drying out.

With this simple circuit in FIG. 1, in normal operation of the electrolysis module 3, the latter is supplied with water for the electrolysis reaction, where the water simultaneously also serves to cool the cells. As product gas from the electrolysis, hydrogen H2 produced is conducted together with excess water in a phase mixture into the gas separator 5 for hydrogen. A phase separation takes place in the gas separator 5, and the gaseous hydrogen H2 is separated from the liquid water and withdrawn from the circuit via the gas conduit 19 for the hydrogen H2 and used further. In order to maintain the circulation of water in the circuit, the circulation pump 4 is provided in the circuit. Consumed water is additionally compensated for by replenishing demineralized water (DM water) into the gas separator 5 via a feed conduit 21 having a control valve 23.

The gas separator 5 is designed and disposed at a height differential Δh above the electrolysis module 3 such that, in the event of a stoppage, the electrolysis module 3 or, as necessary, further electrolysis modules 3b, 3c in the module arrangement 27 as well is floodable automatically with water via the bypass conduit 15, driven solely by a hydrostatic pressure differential Δp via the height differential Δh. The height differential Δh is set here such that the available effective and driving pressure differential between the fill level LM in the electrolysis module 3 and the fill level LS in the gas separator 5 that is provided is at least 0.05 bar to 0.5 bar, in particular 0.1 bar to 0.3 bar; see also FIG. 2 in this regard, in which the principle of level balancing is illustrated.

The flooding concept for the electrolysis module 3 is entirely autonomous and intrinsically very reliable. It is independent of additional and complex external supplies and redundant systems or backup solutions for conveying or flooding by means of pumps. By design and arrangement of the gas separator 5 at a sufficient height above the electrolysis module 3, in operation, a fill height LS or a level LS of the water is regularly maintained in the gas separator 5, and a hydrostatic delivery pressure is already intrinsically provided in the system for any necessary shutdown operation, particularly in the event of a safety-related emergency shutdown. The flooding concept is of course also advantageously utilizable for a regular and planned shutdown, for instance for servicing purposes.

The gas separator 5 is configured here as a horizontal vessel with a maximum surface area 11 as phase interface, as a result of which particularly effective phase separation and reduced build space in terms of build height in particular is possible, in spite of an elevated arrangement of the gas separator 5 compared to the electrolysis module 3 at the height differential Δh.

The circulation pump 13 in the return conduit 9 is optionally designed such that it has a low pressure drop coefficient at stoppage, such that rapid flooding is ensured in joint cooperation with the gas separator 5 emptying via the return conduit 9. Typical pressure drop coefficients ζ envisaged here for the circulation pump are less than ζ=5, in particular less than ζ=3. This is an advantageous optional precautionary measure and creates redundancy in a simple manner, which creates not only the primarily established flooding via the bypass conduit 15 but also an additional flow path via the return conduit 9. In general, however, there are no particular measures, restrictions or precautions that should be noted for the return conduit 9 with respect to the pressure drop coefficients ζ of the components.

In normal operation or regular operation of the electrolyzer 1, the electrolysis module 3 is supplied with an electrolysis current, such that water is converted to hydrogen H2 and oxygen as product gas in the electrolysis module 3. Hydrogen H2 is fed to the gas separator 5 in a phase mixture with water as product gas, with separation of the water from hydrogen H2 in the gas separator 5. In stoppage operation, the electrolysis current is stopped instantaneously, and a safety shutdown is initiated without delay. Here, the fitting 17 in the bypass conduit 15 is opened automatically. By configuring the fitting 17 as, for example, a solenoid valve that is normally closed, the fitting opens automatically in the de-energized state via a released spring. Another configuration of the fitting 17 is possible, in the form of a simple check valve, which is closed in normal operation because of a pressure differential over the check valve, and in stoppage operation the pressure differential over the check valve is reduced or disappears, such that the flow path for the flooding via the bypass conduit 15 is rapidly released. Water is thus driven automatically out of the gas separator 5 into the electrolysis module 3 owing to the height differential Δh, such that the electrolysis module 3 is completely flooded with water. The electrolysis module is automatically flooded here with water until the fill level LS of the water in the gas separator 5 and the fill level LM in the electrolysis module are balanced. A safe steady-state condition is thus achieved, and the electrolysis module 3 with its critical components such as membrane and electrodes are completely soaked in water. Running-dry is inherently prevented, in particular without having to resort to active electrical supply systems or redundant backup solutions.

The flooding concept of the invention may be applied flexibly to more complex electrolyzers 1 with regard to safety-related design and configuration. For instance, multiple electrolysis modules 3, 3a, 3b, which are connected together to form a module arrangement 27, may be envisaged. By way of example, three electrolysis modules 3, 3b, 3c are envisaged in FIG. 1, which are connected to the gas separator 5 via a common product flow conduit 7. To this end, on the outlet side of the electrolysis modules 3a, 3b, 3c, a respective conduit—not shown in detail in the module arrangement 27—opens into the common product flow conduit 7. It is additionally also possible here that the electrolysis modules 3a, 3b, 3c are connected to the return conduit 9 via a respective terminal conduit, which is not shown in detail in the module arrangement 27. A control fitting is then provided in each of the respective terminal conduits, such that individual actuation and controlled return of water to an electrolysis module 3, 3a, 3b in normal operation is achieved. If necessary or optionally, said control fittings may also be mechanically designed for a minimum flow below which the flow cannot be reduced during control, such that rapid and largely unhindered backflow through the return flow conduit 9 for flooding of one or more of the electrolysis modules 3, 3b, 3c is achievable redundantly or as an alternative to the preferred flooding via the bypass conduit 15. In the case of this configuration as well, in the event of an emergency, water is then driven automatically out of the gas separator 5 into one or more of the electrolysis modules 3, 3a, 3b owing to the height differential Δh, such that the shut-down electrolysis module 3, 3a, 3b is specifically completely flooded with water within a short time.

A diagram with the progression of the fill level L over time in the event of a safety shutdown is shown in simplified form in FIG. 2, in order to illustrate the principle. Plotted on the abscissa is the time t, and plotted on the ordinate, as a function of the time t, is the level L that characterizes the progression of the fill level of the corresponding component with water over time. Starting from a time to, coming from normal operation, a stoppage operation of the electrolyzer 1 is initiated, for example initiated by switching off the electrolysis current. At this juncture, there is a level LS in the gas separator 5 and a level LM in the electrolysis module 3. Here, at this juncture, LS>LM, such that, initially in the electrolyzer 1, a correspondingly high differential pressure Δp is available as driving force owing to the predetermined height differential Δh for rapid flooding by level balancing. A fill-level differential LS>LM (difference in level) is associated with the height differential Δh and provides the predetermined driving differential pressure Δp owing to a hydrostatic pressure differential for the flooding.

In the stoppage operation at time to, the electrolysis current is stopped and a safety shutdown is initiated. Water is driven here automatically out of the gas separator 5 into the electrolysis module 3 owing to the height differential Δh, and the electrolysis module 3 is rapidly flooded with water. Flooding proceeds automatically with water owing to the hydrostatic differential pressure Δp until the fill level LS of water in the gas separator 5 and the fill level or the level LM in the electrolysis module 3 are balanced and accordingly the differential pressure Δp=0. The fill level or level LS of water in the gas separator 5 decreases with time t, whereas the fill level or level LM in the electrolysis module 3 increases correspondingly over time until the two fill levels LM and LS are the same and are at a level LA. Here, there is a balanced level LA or fill level, and the flooding process is completed. Level balancing is thus brought about within a very short time, thus defining a relatively short time tA at which the flooding process via the bypass conduit 15 is completed. This period of time tA for level balancing, depending on the design of the electrolyzer 1, is only about 60-300 seconds up to a few minutes. In the case of larger plants and volume flow rates of water or in the case of multiple electrolysis modules 3, 3a, 3b to be flood simultaneously, the period of time tA for level balancing up to level LA may also be greater, for instance 10 to 30 minutes, in particular about 15-20 minutes. This is sufficiently rapid to prevent running-dry reliably and with the simple means described here.

When the power supply and hence the eletrolysis process suddenly stops, gas and water will separate in the electrolysis module 3. A certain water level LM will be established in the electrolysis module 3. Because the gas separator 5 in the electrolysis plant is disposed at an appropriate height differential Δh well above the electrolysis module 3 and the bypass conduit 15 having the automatically and instantaneously opening fitting 17 has a low pressure drop coefficient ζ, very rapid flow can occur through the conduction pathway through the bypass conduit with bypassing of the return flow conduit 9, and very rapid level balancing takes place automatically. The height differential Δh is adjusted in accordance with the effective pressure drop coefficient ζeff of the overall flow pathway of the bypass conduit, though the simple conduction pathway here means that particular restrictions due to pressure drop are not a matter of concern and a moderate height differential Δh by appropriate positioning of the gas separator 3 above the electrolysis module is sufficient.

The flow path via the return conduit 9, with respect to the incorporation of active components such as the circulation pump 13, the heat exchanger 25 and the control valve 23, is not subject to any particular restrictions with regard to the influence of the pressure drop coefficient ζeff. Optionally, it is however possible and advantageous for the return conduit 9 including any flow elements present, such as pumps or valves, to be adapted accordingly and to be taken into account accordingly when designing an electrolyzer 1. Thus, another flow path in addition to the bypass conduit 15 can optionally be kept ready for rapid flooding, if it should be necessary.

The invention provides a self-regulating flooding concept for an electrolyzer 1 with very high reliability; e failure of active components is impossible, since no active components are employed. High plant reliability of an electrolyzer 1 and very effective protection of an electrolysis module 3 or multiple electrolysis modules 3, 3a, 3b in a module arrangement 27 from running dry are specifically also maintained here in possible fault situations. Examples of such fault situations include a power outage, failure of the pump actuation, failure of the control valve actuation, incorrect operation or pump damage. Moreover, a very simple and inexpensive solution is thus provided, since no complex additional equipment is required apart from the bypass conduit 15 having the fitting 17, but merely the controlled and intelligent utilization of the existing equipment and the design of the electrolyzer 1. The use of the concept is possible and highly advantageous particularly for any electrolyzer—atmospheric or pressurized—with a pump arrangement in the circuit.

1. An electrolyzer for production of hydrogen (H₂) and oxygen (O₂) as product gases, comprising:
an electrolysis module; and comprising
a gas separator designed for phase separation of the product gas from water, in which the electrolysis module is connected to the gas separator via a product flow conduit for the product gas, and in which a return conduit for the water removed is provided, which fluidically connects the gas separator to the electrolysis module, wherein a circulation pump is connected into the return conduit,
characterized in that a bypass conduit having a fitting is provided, which connects the gas separator to the electrolysis module, wherein at least part of the return conduit is fluidically bypassed by the bypass conduit, and wherein the bypass conduit having the fitting is designed such that water is autonomously suppliable from the gas separator to the electrolysis module via the bypass conduit in stoppage operation, wherein rapid flooding of the electrolysis module is ensured and the electrolysis module is prevented from running dry.

2. The electrolyzer as claimed in claim 1, in which the gas separator is designed and disposed at a predetermined height differential (Δh) above the electrolysis module such that, in an event of a stoppage, the electrolysis module is automatically floodable with water via the bypass conduit, driven solely by a hydrostatic differential pressure (Δp).

3. The electrolyzer as claimed in claim 1, in which a height differential (Δh) is adjusted such that a driving differential pressure (Δp) provided for the flooding is at least 0.05 bar to 0.5 bar, in particular 0.1 bar to 0.3 bar.

4. The electrolyzer as claimed in claim 1, in which the gas separator is configured as a horizontal vessel, such that a large surface area is provided as phase interface between liquid and gaseous phases.

5. The electrolyzer as claimed in claim 1, in which the bypass conduit opens directly into a lower region of the electrolysis module or into the return conduit with bypassing of the circulation pump on a discharge side thereof.

6. The electrolyzer as claimed in claim 1, in which the fitting in the bypass conduit is configured as a valve, in particular as a solenoid valve which opens automatically in an de-energized state.

7. The electrolyzer as claimed in claim 1, in which the fitting is configured as a check valve which, in an event of a stoppage, opens automatically owing to a hydrostatic differential pressure (Δp).

8. The electrolyzer as claimed in claim 1, in which at least two fittings are provided, which are fluidically parallel-connected into the bypass conduit.

9. The electrolyzer as claimed in claim 1, in which multiple electrolysis modules are provided, which are connected to the gas separator via a common product flow conduit.

10. The electrolyzer as claimed in claim 1, in which a control valve (23) is connected into the return conduit on a discharge side of the circulation pump.

11. The electrolyzer as claimed in claim 10, in which a heat exchanger (25) is connected into the return conduit between the circulation pump and the control valve.

12. A method of operating an electrolyzer, in which an electrolysis current is supplied to an electrolysis module in normal operation, such that water is converted to hydrogen (H₂) and oxygen as product gases in the electrolysis module, wherein product gas is supplied to a gas separator in a phase mixture of water and product gas, wherein water is separated from product gas in the gas separator, and wherein, in stoppage operation, the electrolysis current is stopped and a safety shutdown is initiated, characterized in that water is driven out of the gas separator automatically into the electrolysis module on account of a hydrostatic differential pressure (Δp) associated with a predetermined height differential (Δh), wherein the electrolysis module is flooded with water, wherein rapid flooding of the electrolysis module is ensured and the electrolysis module is prevented from running dry.

13. The method as claimed in claim 12, in which a safety shutdown involves automatic opening of a fitting and driving of the water into the electrolysis module via a bypass conduit.

14. The method as claimed in claim 12, in which automatic flooding with water is carried out until a fill level (Lₛ) of water in the gas separator and the fill level (L_{M}) in the electrolysis module are balanced.
